(19) United States
(12) Patent Application Publication
(10) Pub. No.: US 2025/0377582 A1
(43) Pub. Date: Dec. 11, 2025

(54) Camera Eyeline Alignment Device

(71) Applicant: Miguel Chavarria, Mesa, AZ (US)

(72) Inventor: Miguel Chavarria, Mesa, AZ (US)

(21) Appl. No.: 19/211,396

(22) Filed: May 19, 2025

Related U.S. Application Data
(60) Provisional application No. 63/657,174, filed on Jun. 7, 2024.

(51) Int. Cl. G03B 17/56; G06F 1/16

(52) U.S. Cl. CPC G03B 17/566; G06F 1/1607; G03B 2217/002

(57) ABSTRACT

A camera eyeline alignment device is provided. The device is comprised of mechanical and visual assembly configured to guide a user's gaze toward the optical axis of a camera lens. The device comprises an attachment mechanism removably securable to a display structure or camera housing. The device is further comprised of a body coupled to the attachment mechanism and includes at least one receiving area for stowing an extendable arm. The arm may be fixed, foldable, telescopic, or segmented, and may incorporate pivot points that allow angular adjustment through joints such as hinges or ratcheting mechanisms. The arm further includes at least one magnetic docking point designed to secure a visual reference marker composed of magnetically responsive material. The visual reference marker may be formed in various shapes and colors, and may include alignment lines to aid in precise positioning relative to the camera lens.

### CROSS REFERENCE TO RELATED APPLICATION

The present application claims priority to, and the benefit of, U.S. Provisional Application No. 63/657,174, which was filed on Jun. 7, 2024, and is incorporated herein by reference in its entirety.

### FIELD OF THE INVENTION

The present invention relates generally to the field of video production. More specifically, the present invention relates to a camera-attachable device that enables users to maintain consistent eye contact with a camera lens during self-taped auditions. Accordingly, the present disclosure makes specific reference thereto. Nonetheless, it is to be appreciated that aspects of the present invention are also equally applicable to other like applications, devices, and methods of manufacture.

### BACKGROUND

In the context of self-taped auditions, maintaining accurate and consistent eyelines is critical for actors to deliver a professional and believable performance. The process of self-recording introduces challenges related to visual engagement, particularly the tendency of actors to misalign their gaze in relation to the camera lens. This misalignment can create a visual disconnect that distracts casting professionals and diminishes the perceived quality of the performance. Unlike in-person auditions, where a casting director can guide sightlines, self-taping requires the actor to independently manage visual focus, which often results in unintended eye movements or gaze direction that fails to simulate authentic interaction. Furthermore, this issue is not limited to auditions alone, as it extends to professional video conferencing, online teaching, and content creation, where the perception of direct eye contact significantly impacts viewer trust and engagement. Despite the growing reliance on video communication, there remains a lack of practical tools specifically designed to address this aspect of user-camera interaction. Existing solutions are either improvised or insufficient in guiding consistent eyelines. As a result, there exists a substantial need for a dedicated device that ensures precise alignment between the user's gaze and the camera lens, thereby preserving natural communication dynamics. A specialized solution would aid actors and other video content creators by providing a stable, repeatable reference for proper eyeline positioning.

Therefore, there exists a long-felt need in the art for a camera eyeline alignment device that enables users to maintain consistent eye contact with a camera lens during self-taped auditions. There also exists a long-felt need in the art for a camera eyeline alignment device that provides an easily adjustable and secure attachment mechanism compatible with various display structures and camera housings. Moreover, there exists a long-felt need in the art for a camera eyeline alignment device that incorporates an interchangeable visual reference marker to simulate direct viewer engagement.

The subject matter disclosed and claimed herein, in one embodiment thereof, comprises a camera eyeline alignment device. The device is comprised of mechanical and visual assembly configured to guide a user's gaze toward the optical axis of a camera lens. The device comprises an attachment mechanism removably securable to a display structure or camera housing. The device is further comprised of a body coupled to the attachment mechanism and includes at least one receiving area for stowing an extendable arm. The arm may be fixed, foldable, telescopic, or segmented, and may incorporate pivot points that allow angular adjustment through joints such as hinges or ratcheting mechanisms. The arm further includes at least one magnetic docking point designed to secure a visual reference marker composed of magnetically responsive material. The visual reference marker may be formed in various shapes and colors and may include alignment lines to aid in precise positioning relative to the camera lens. The device is operable through a method comprising attachment to a mounting surface, extension and adjustment of the arm, placement of the visual marker, and alignment of the user's gaze toward the marker during operation.

In this manner, the camera eyeline alignment device of the present invention accomplishes all the foregoing objectives and provides a device that enables users to establish and maintain a consistent sightline with a camera lens, thereby improving the quality and authenticity of visual communication during self-taped auditions and other video interactions. The inclusion of multiple attachment mechanisms ensures compatibility with a wide range of devices, supporting flexibility and ease of use. The articulated arm and magnetic docking system allow precise adjustment and positioning of the visual marker, ensuring accurate and repeatable alignment of the user's gaze with the camera's optical axis. By addressing the problem of inconsistent eyelines and the associated visual disconnect, the device facilitates more effective viewer engagement, ultimately meeting the long-felt needs in the field of digital performance and communication.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a camera eyeline alignment device. The device is designed to optimize eyeline alignment during video recordings, calls, and livestreams by aligning the user's gaze with the camera lens to simulate direct eye contact. This functionality enhances viewer engagement and communication clarity by reducing the disconnect caused when users look at a screen rather than the camera. Eyeline alignment is achieved through the placement of a visual reference marker positioned coaxially or adjacently to the camera lens. By focusing on this marker, the user's gaze appears as direct eye contact to viewers, which is beneficial in professional and broadcast contexts.

The device is comprised of an attachment mechanism configured to removably secure the device to various display structures, including laptop bezels and external camera housings. One embodiment includes a spring-loaded clip applying constant pressure for firm engagement. The attachment mechanism may include contact surfaces with a padding layer designed to enhance grip, distribute pressure, and prevent damage.

The device includes a body coupled to the attachment mechanism, with a receiving area to house a retractable or foldable arm. The arm may be fixed, telescopic, or segmented, with segments joined by pivot points allowing angular adjustments for precise positioning.

The arm includes at least one magnetic docking point designed to hold an interchangeable visual reference marker. When the marker is positioned near the camera lens, the user's gaze is aligned with the camera's field of view to simulate eye contact.

Each visual reference marker may be comprised of magnetically responsive materials and produced in various shapes and colors. The docking point may also include alignment lines to assist in precise marker placement and promote consistent sightline orientation.

A method of using the device includes securing the device to a display structure, extending and adjusting the arm to position the docking point near the camera lens, attaching and aligning the visual marker, directing gaze toward the marker during video activity, and optionally detaching the device using the quick-release mechanism.

Accordingly, the camera eyeline alignment device of the present invention is particularly advantageous as it provides a device that enables users to establish and maintain a consistent sightline with a camera lens, thereby improving the quality and authenticity of visual communication during self-taped auditions and other video interactions. The inclusion of multiple attachment mechanisms ensures compatibility with a wide range of devices, supporting flexibility and ease of use. The articulated arm and magnetic docking system allow precise adjustment and positioning of the visual marker, ensuring accurate and repeatable alignment of the user's gaze with the camera's optical axis. By addressing the problem of inconsistent eyelines and the associated visual disconnect, the device facilitates more effective viewer engagement, ultimately meeting the long-felt needs in the field of digital performance and communication.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a camera eyeline alignment device of the present invention with the arms folded in accordance with the disclosed architecture;

FIG. 2 illustrates a perspective view of one potential embodiment of a camera eyeline alignment device of the present invention with the arms unfolded and while attached to a tablet in accordance with the disclosed architecture;

FIG. 3 illustrates a perspective view of one potential embodiment of a camera eyeline alignment device of the present invention with the arms unfolded in accordance with the disclosed architecture;

FIG. 4 illustrates a flowchart of a method of using one potential embodiment of a camera eyeline alignment device of the present invention in accordance with the disclosed architecture; and

FIG. 5 illustrates a graphical view of features of a mobile application of one potential embodiment of a camera eyeline alignment device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a camera eyeline alignment device that enables users to maintain consistent eye contact with a camera lens during self-taped auditions. There also exists a long-felt need in the art for a camera eyeline alignment device that provides an easily adjustable and secure attachment mechanism compatible with various display structures and camera housings. Moreover, there exists a long-felt need in the art for a camera eyeline alignment device that incorporates an interchangeable visual reference marker to simulate direct viewer engagement.

The present invention, in one exemplary embodiment, is comprised of a camera eyeline alignment device. The device is designed to enhance eyeline alignment during video recordings, calls, and livestreams by directing the user's gaze toward the camera lens to simulate direct eye contact. This feature improves viewer engagement and communication clarity by minimizing the disconnect caused when the user looks at a display screen instead of the camera. Eyeline alignment is facilitated by positioning a visual reference marker either coaxially or adjacently to the camera lens. When the user focuses on the marker, the resulting gaze is perceived as direct eye contact, which is particularly useful in professional and broadcast applications.

The device is comprised of an attachment mechanism configured to removably secure the device to various display structures, including laptop bezels and external camera housings. One embodiment includes a spring-loaded clip that applies constant pressure to maintain firm engagement. The attachment mechanism may include contact surfaces with a padding layer intended to improve grip, distribute pressure evenly, and prevent surface damage.

The device further includes a body coupled to the attachment mechanism, with a receiving area for housing a retractable or foldable arm. The arm may be fixed, telescopic, or segmented, with segments connected by pivot points that enable angular adjustments for precise positioning.

The arm is comprised of at least one magnetic docking point designed to retain an interchangeable visual reference marker. When positioned near the camera lens, the marker aligns the user's gaze with the camera's field of view to simulate eye contact.

Each visual reference marker may be comprised of magnetically responsive materials and may be manufactured in various shapes and colors. The docking point may incorporate alignment lines to aid in precise marker positioning and to ensure consistent sightline orientation.

A method of using the device includes securing the device to a display structure, extending and adjusting the arm to place the docking point near the camera lens, magnetically attaching and aligning the visual marker, directing the user's gaze toward the marker during video activity, and, if needed, detaching the device using a quick-release mechanism.

As a result, the camera eyeline alignment device is particularly advantageous in that it enables users to establish and maintain a consistent gaze toward a camera lens, improving the authenticity and quality of visual communication during self-taped auditions and other video interactions. The inclusion of multiple attachment mechanisms supports compatibility with various devices, providing flexibility and ease of use. The articulated arm and magnetic docking system allow precise adjustment and reliable positioning of the visual marker, ensuring accurate and repeatable gaze alignment with the camera's optical axis. By addressing the issue of inconsistent eyelines and the resulting visual disconnect, the device promotes more effective viewer engagement and fulfills longstanding needs in digital performance and communication.

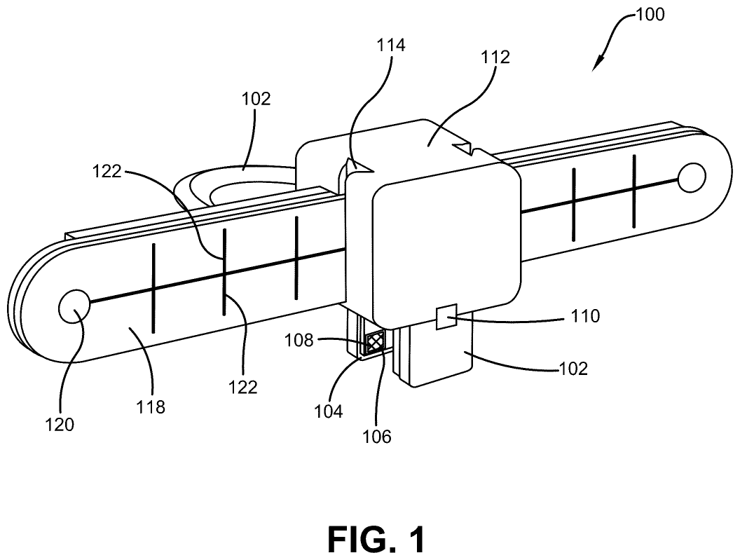

Referring initially to the drawings, FIG. 1 illustrates a perspective view of one potential embodiment of a camera eyeline alignment device 100 of the present invention with the arms 116 folded in accordance with the disclosed architecture. The device 100 is designed to optimize and maintain precise eyeline alignment during video recordings, video calls, and livestreams by employing a combination of mechanical and visual components that enhance presentation clarity and foster a more natural visual connection with viewers. The device 100 may also be suited for use by digital content creators such as livestreamers, YouTubers, TikTok creators, and similar online broadcasters. The primary function of the device 100 is to establish a consistent and intentional sightline that aligns the user's gaze with the camera lens, which is critical in maintaining the perception of direct eye contact between the speaker and the viewer. By elevating the user's line of sight to intersect with the optical axis of the camera, the device 100 mitigates the common disconnect caused by users looking at a display screen rather than the camera itself.

This alignment of the sightline may be achieved through the strategic positioning of a visual reference marker 124, which provides a dedicated focal point coaxial or adjacent to the camera lens. When the user directs visual attention to the marker 124, the resulting gaze is perceived by the viewer as direct eye contact. This fosters engagement, increases viewer trust, and enhances communication efficiency, especially in professional, educational, and broadcast settings. In one embodiment, multiple markers 124 may be employed simultaneously in a dual-eyeline mode to support multi-character eyeline alignment. Each marker 124 may be distinguished by color or shape to signify different characters or roles. The user may rapidly alternate between marker positions by detaching and reattaching the markers 124 at the magnetic docking points 122 as needed (which will be explained more fully below), supporting dynamic eyeline adjustments during performance.

The device 100 may be comprised of an attachment mechanism 102 configured to removably secure the device 100 to a display structure such as but not limited to the upper bezel of a laptop, tablet, or desktop monitor. In one embodiment, the attachment mechanism 102 may be comprised of a spring-loaded clip or clamp, configured to apply constant pressure across contact surfaces to ensure firm engagement with the display structure.

Alternative embodiments of the attachment mechanism 102 may include but are not limited to adhesive fasteners, suction cup fasteners, magnetic fasteners, mechanical latches, hook-and-loop fabric strips, or other reversible securing means. In another embodiment, the attachment mechanism 102 may be comprised of a flexible loop formed from silicone or elastomeric material, dimensioned to stretch and fit securely around the outer diameter of a camera lens. This silicone loop configuration may be particularly suited for external webcams, DSLR cameras, or other standalone imaging devices where bezel mounting is not feasible. The device 100 may feature numerous attachment mechanisms 102 in different embodiments. In some embodiments, the overall structure of the device 100 may be configured to be compact and collapsible, allowing for ease of transport by actors or content creators traveling between locations. Such a design may be comprised of foldable, collapsible, and/or telescopic components that stow flat and do not obstruct the camera lens, preserving clean image capture during use.

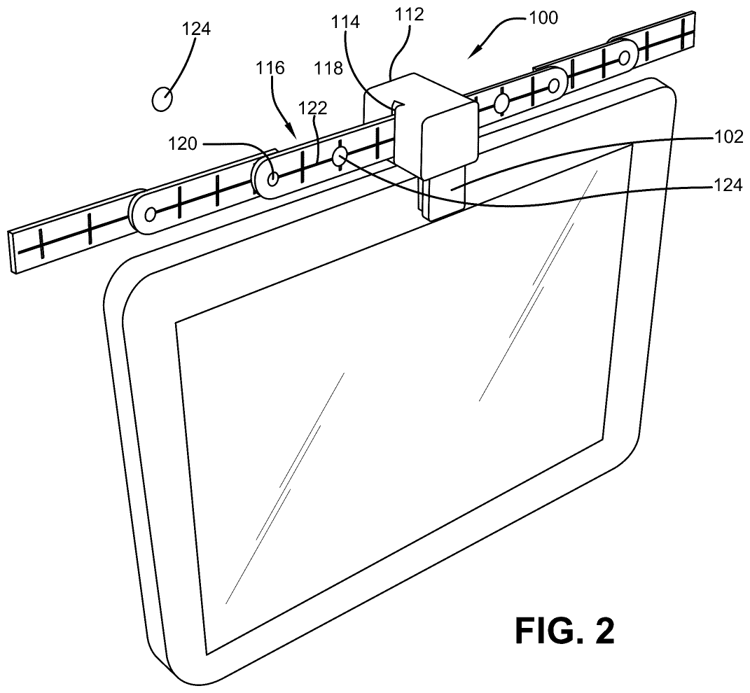

The contact surfaces 104 of the attachment mechanism 102, which interface with the surface of the display structure or camera housing as seen in FIG. 2, may be equipped with a padding layer 106. The padding 106 may serve to improve grip, distribute pressure evenly, and prevent cosmetic or structural damage to the mounting surface. The padding 106 may be comprised of material such as but not limited to silicone rubber, thermoplastic elastomer (TPE), polyurethane foam, or felt. The padding 106 may further be comprised of a grip texture 108 such as but not limited to ribbed, dimpled, embossed, or micro-perforated patterns. These textures 108 may enhance friction and reduce slippage under different environmental or usage conditions.

In one embodiment, the attachment mechanism 102 may also be comprised of a quick-release mechanism 110 configured to allow for rapid detachment of the device 100 from the display structure. The quick-release mechanism 110 may include but is not limited to a push-button actuator, sliding latch, toggle lever, or twist-lock disengagement element.

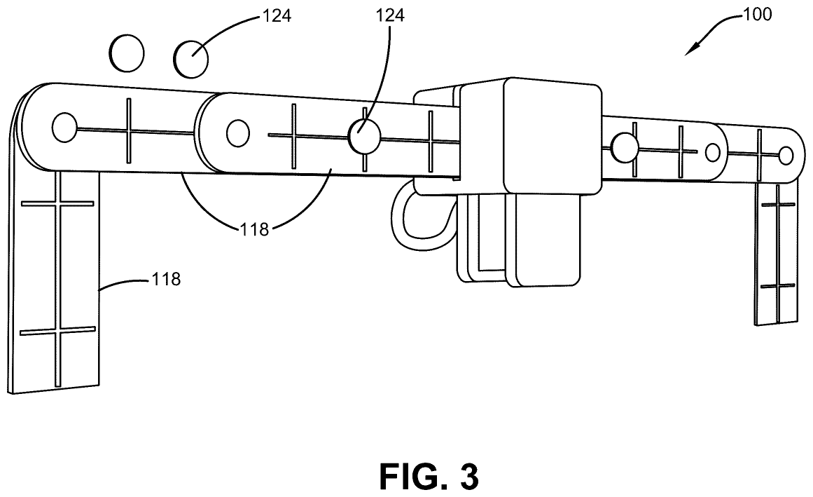

The device 100 may be further comprised of a body 112 coupled to or integrally formed with the attachment mechanism 102. The body 112 may be comprised of at least one receiving area 114 designed to house at least one arm 116 when the arm 116 is in a retracted or stowed position. The arm 116 may be of a fixed length in some embodiments, while in alternative embodiments the arm 116 may be telescopic, foldable, or comprised of a plurality of segments 118. In one embodiment, the pivot points 120 may be configured to permit not only angular adjustment but also to allow the segments 118 to be removably attached to one another, enabling modular assembly of the arm 116 based on the desired length or configuration. In a segmented embodiment, the segments 118 may be connected to each other via at least one pivot point 120. Each pivot point 120 may be comprised of a mechanical joint such as but not limited to a ball-and-socket joint, hinge joint, friction hinge, or detent-based rotary joint. In one embodiment, the pivot point 120 may be a ratcheting joint configured to allow incremental angular adjustments and secure locking at defined positions, as seen in FIG. 3. The pivot points 120 may permit precise angular orientation and positioning of the arm 116 to accommodate various user preferences, camera locations, and eyeline positions.

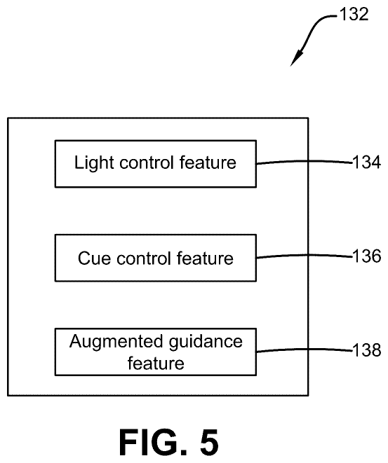

The arm 116 may be comprised of at least one magnetic docking point 122. Each docking point 122 may be configured to securely hold an interchangeable visual reference marker 124, as seen in FIG. 2 and FIG. 3. The markers 124 are designed to simulate a consistent sightline by offering a stable visual cue for the user to focus on. This simulated sightline is achieved when the marker 124 is positioned in close proximity to or directly in front of the camera lens, thereby ensuring that the user's gaze aligns with the camera's field of view. In one embodiment, the marker 124 may be comprised of a light-emitting element 130 such as an LED or programmable lighting module configured to emit light cues during recording. The light-emitting element 130 may optionally be synchronized with a companion mobile application 132, as seen in FIG. 5. The mobile application 132 may be comprised of a lighting control feature 134 configured to adjust the brightness, pattern, and timing of the light-emitting element 130. The application 132 may further be comprised of a cue timing feature 136 configured to deliver actor prompts or performance timing signals. Additionally, the application 132 may be comprised of an augmented guidance feature 138 configured to display visual overlays or placement templates through the user's mobile device interface, aiding in optimal positioning of the visual reference marker 124 relative to the camera lens.

Each visual reference marker 124 may be comprised of magnetically responsive material such as but not limited to neodymium, ferrite, or samarium-cobalt composites. The markers 124 may be of any shape, such as spherical, cuboidal, cylindrical, conical, or abstract forms, and may be any color to accommodate different user preferences or visibility requirements. In one embodiment, the docking point 122 may be in the form of a vertical and/or horizontal alignment line. These alignment lines may visually assist the user in properly orienting the marker 124 relative to the camera lens to maximize the effectiveness of simulated eye contact. The inclusion of such alignment features may support rapid and repeatable marker placement, reducing set-up time and increasing user confidence in achieving optimal sightline orientation. To enhance visibility and reduce glare, the marker 124 may also be manufactured from anti-glare, reflective, glow-in-the-dark, or phosphorescent materials. In some embodiments, the light-emitting element 130 may provide adjustable brightness or color for visual emphasis.

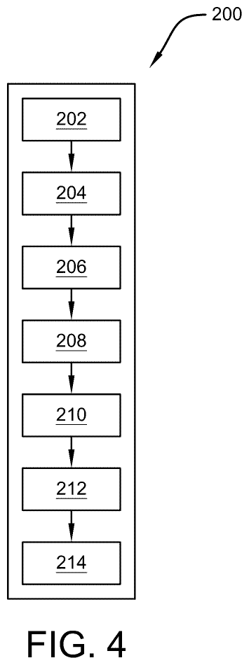

The present invention is also comprised of a method of using the device 100, as seen in FIG. 4. First, a device 100 is provided comprised of a body 112 coupled to an attachment mechanism 102, at least one arm 116 with at least one pivot point 120 and at least one magnetic docking point 122, and at least one visual reference marker 124. Then, the attachment mechanism 102 can be removably secured to a display structure or camera housing using a spring-loaded clip, adhesive fastener, suction cup, magnetic fastener, mechanical latch, hook-and-loop fabric strip, or a flexible silicone loop, depending on the configuration of the device 100. Next, the arm 116 can be extended or unfolded from the body 112 and angularly adjusted at the pivot point 120 to position the magnetic docking point 122 in proximity to the camera lens. Afterward, the visual reference marker 124 can be magnetically affixed to the docking point 122 and aligned using any provided visual alignment lines to ensure it is coaxial or adjacent to the camera lens. Subsequently, the user can direct their gaze toward the marker 124 during video recording, video calls, or livestreaming, thereby simulating direct eye contact through alignment with the camera's optical axis. Finally, if necessary, the quick-release mechanism 110 can be activated to rapidly detach the device 100 from the display structure or camera housing for storage or repositioning. In one embodiment, the user may further operate the mobile application 132 in parallel with the device 100 to receive visual guidance, timing cues, or character-specific prompts for dual-marker use. The lighting control module 134, cue timing module 136, and augmented guidance module 138 may each be configured to operate independently or in combination, depending on the user's workflow requirements.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “camera eyeline alignment device” and “device” are interchangeable and refer to the camera eyeline alignment device 100 of the present invention.

Notwithstanding the foregoing, the camera eyeline alignment device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the camera eyeline alignment device 100, as shown in the FIGS. are for illustrative purposes only, and that many other sizes and shapes of the camera eyeline alignment device 100 are well within the scope of the present disclosure. Although the dimensions of the camera eyeline alignment device 100 are important design parameters for user convenience, the camera eyeline alignment device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A camera eyeline alignment device comprising:
an attachment mechanism;
a body coupled to the attachment mechanism;
an arm coupled to the body; and
a visual reference marker removably attached to the arm, wherein the visual reference marker is positioned in proximity to a camera lens to align the user's gaze with an optical axis of the camera lens.

2. The camera eyeline alignment device of claim 1, wherein the attachment mechanism is comprised of a spring-loaded clip.

3. The camera eyeline alignment device of claim 1, wherein the attachment mechanism is comprised of a flexible loop.

4. The camera eyeline alignment device of claim 1, wherein the attachment mechanism is comprised of a quick-release mechanism.

5. The camera eyeline alignment device of claim 1, wherein the attachment mechanism is comprised of a padding layer.

6. The camera eyeline alignment device of claim 5, wherein the padding layer is comprised of a grip texture.

7. The camera eyeline alignment device of claim 1, wherein the arm is comprised of a folding arm.

8. The camera eyeline alignment device of claim 1, wherein the arm is comprised of a telescopic arm.

9. A camera eyeline alignment device comprising:
an attachment mechanism;
a body coupled to the attachment mechanism;
an arm coupled to the body, the arm comprised of a pivot point and a magnetic docking point; and
a visual reference marker magnetically affixed to the magnetic docking point, wherein the visual reference marker is positioned in proximity to a camera lens to align the user's gaze with an optical axis of the camera lens.

10. The camera eyeline alignment device of claim 9, wherein the pivot point is comprised of a ratcheting joint.

11. The camera eyeline alignment device of claim 9, wherein the attachment mechanism is comprised of a spring-loaded clip.

12. The camera eyeline alignment device of claim 9, wherein the attachment mechanism is comprised of a flexible loop.

13. The camera eyeline alignment device of claim 9, wherein the attachment mechanism is comprised of a quick-release mechanism.

14. The camera eyeline alignment device of claim 9, wherein the attachment mechanism is comprised of a padding layer.

15. The camera eyeline alignment device of claim 14, wherein the padding layer is comprised of a grip texture.

16. The camera eyeline alignment device of claim 9, wherein the magnetic docking point is comprised of a vertical line.

17. The camera eyeline alignment device of claim 9, wherein the magnetic docking point is comprised of a horizontal line.

18. A method of using a camera eyeline alignment device, the method comprising the following steps:
providing a camera eyeline alignment device comprised of a body coupled to an attachment mechanism, an arm comprised of a magnetic docking point, wherein the arm is attached to the body, and a visual reference marker;
removably securing the attachment mechanism to a display structure or a camera housing;
extending the arm from the body;
affixing the visual reference marker to the magnetic docking point;
aligning the visual reference marker to be coaxial or adjacent to a camera lens of the display structure or the camera housing; and
looking toward the visual reference marker to align a user's sightline with an optical axis of the camera lens.

19. The method of using a camera eyeline alignment device of claim 18 further comprising adjusting a pivot point of the arm.

20. The method of using a camera eyeline alignment device of claim 18 further comprising activating a quick-release mechanism of the attachment mechanism.
